(19) United States
(12) Patent Application Publication
(10) Pub. No.: US 2011/0257909 A1
(43) Pub. Date: Oct. 20, 2011

(54) INERTIALLY REFERENCED SENSOR SYSTEM AND METHOD

(75) Inventors: Bradley Allen, Sunnyvale, CA (US); Paul Janzen, Sunnyvale, CA (US)

(73) Assignee: MOOG INC., East Aurora, NY (US)

(21) Appl. No.: 12/760,304

(22) Filed: Apr. 14, 2010

(51) Int. Cl. G06F 19/00; G01P 15/00; G01B 11/14

(52) U.S. Cl. 702/56; 356/614; 73/514.01; 702/141

(57) ABSTRACT

An inertially referenced motion sensor that may be rigidly coupled to a relative motion sensor. Signals from the relative motion sensor and inertially referenced motion sensor may be combined to produce an inertially referenced relative signal.

### TECHNICAL FIELD

The disclosed subject matter of this application relates to motion measurement systems and, more particularly, to an inertially referenced sensor system and method.

### BACKGROUND ART

A wide variety of applications require precise motion measurements for design, testing, manufacturing, and control, particularly for large, complex mechanical structures. Such motion measurements may include displacement, velocity, acceleration, or jerk measurements, for example. A great deal of time and money may be expended in the course of manufacturing, testing, or operating mechanical structures.

### SUMMARY

In an illustrative apparatus and method in accordance with the principles of claimed subject matter, a plurality of motion sensors may be combined to form an inertially referenced motion sensor. Such a sensor may be a combination of a variety of motion sensors and may provide a variety of inertially referenced signal outputs. The term “motion sensor” will be used herein to refer to a category of sensors, including without limitation displacement, velocity, acceleration, jerk sensors, and fractional combinations of such sensors. The term fractional combination refers to the fact that a sensor may have different outputs over different frequency ranges, such as a velocity output at high frequencies, and a jerk output at low frequencies, and a fractional combination of the two over an intermediate frequency range, for example.

In an illustrative embodiment, signals from two sensors may be combined to form an inertially referenced output signal. One sensor, referred to herein as a relative motion sensor, may be a sensor configured to sense relative motion between itself and an object of measurement, such as a target area on a structure whose vibrational characteristics are being studied. The other sensor, referred to herein as an inertially referenced motion sensor, may be configured to sense any motion of the first relative motion sensor relative to an inertial reference frame. Signals from both sensors may be combined to produce a motion sensor signal that has been referenced to an inertial frame. In an illustrative embodiment, a displacement sensor may be rigidly coupled to an acceleration sensor and their respective signals combined to form an inertially referenced velocity output signal, for example. The displacement sensor may be a non-contact sensor, such as an optical displacement sensor, for example.

A test stand in accordance with the principles of the claimed subject matter may include a support structure and one or more inertially referenced motion sensors configured to test the vibrational characteristics of an object, such as a structure, machine, or article of manufacture, for example. In an illustrative modal analysis vibrational test stand embodiment, a plurality of inertially referenced motion sensors may be mounted on a test stand that supports the sensors in sufficient proximity to a subject structure to allow the sensors to sense the structure's response to one or more driving forces. Signals from the inertially referenced motion sensors may be combined to produce a modal analysis of the object under test. During modal analysis of an object, such as an airframe, inertially referenced motion sensors may provide signals that are substantially free of signal contamination from movement of the test stand. After a set of modal analysis tests (also referred to as ground vibrational tests (GVT)), the object (e.g., airframe) may be moved for other tests, for structural modifications, or for other reasons. The object may then be returned to the test stand for further vibrational testing. Because sensors in accordance with the principles of claimed subject matter need not contact the airframe, they may remain affixed to the test stand and, as a result, remain ready for further testing of the airframe immediately when it is returned to the test stand without requiring time-consuming remounting of sensors.

Alternatively, a plurality of airframes, wings, airframe parts, or other complex mechanical structures may be tested sequentially as they are manufactured; using a test stand in accordance with claimed subject matter, for example. With the structures ostensibly having the same dimensions, structures may be brought to the test stand, tested, and moved to make room for the next structure to be tested. Tests performed with the test stand may be modal analysis or other vibrational tests, for example. Other vibrational tests, such as vibrational testing of engines, for example, are contemplated as falling within the scope of claimed subject matter.

A control system in accordance with the principles of claimed subject matter may include one or more inertially referenced motion sensors. Such a control system may control or inspect the thickness, surface smoothness, or other contour of a manufactured good, for example. A control system in accordance with the principles of claimed subject matter may be employed in the operation of complex equipment, using inertially referenced motion sensors to determine relative movement of one part of the equipment with respect to another part of the equipment, to determine the distance between a moving piece of equipment and a stationary target, or between a moving target and a stationary piece of equipment, for example. For purposes of this discussion, the term “stationary” refers to an object that remains substantially stationary with respect to the surface of the earth, and “non-stationary” refers to an object that exhibits gross motion in relation to the surface of the earth, such as may be exhibited by a vehicle, for example.

Any type of motion sensor (e.g., displacement, velocity, acceleration, or jerk) may employ any sensing technology (e.g., optical, capacitive, or other electromagnetic), using any of a variety of manufacturing technologies, such as hybrid, chip-on-glass, microelectromechanical system (MEMS), analog or digital integrated circuit, or printed circuit manufacturing technologies, for example. Signals developed by individual sensors may be analog or digital signals and they may be post-processed within an inertially referenced motion sensor in accordance with the principles of claimed subject matter. An inertially referenced motion sensor in accordance with the principles of the present invention may employ digital or analog signal inputs or outputs, any of which may employ wireless signaling, for example. Post-processing may include signal conditioning, level-adjustment, digital signal processing, differentiation, or integration, for example.

In an illustrative embodiment an inertially referenced motion sensor in accordance with the principles of claimed subject matter includes a relative motion sensor rigidly fixed to an inertially referenced motion sensor with the relative motion sensor detecting motion of a target relative to the sensor pair and the inertially referenced sensor detecting inertially referenced motion of the sensor pair. The two signals are combined in such a way as to produce a signal representing inertially referenced motion of the target. Such inertially referenced signals representing target motion may then be used in a variety of ways, including dynamic measurement, modal analysis, structural control, and others.

### BRIEF DESCRIPTION OF THE DRAWINGS

Non-limiting and non-exhaustive embodiments will be described with reference to the following Figures, wherein like reference numerals refer to like parts throughout the various Figures unless otherwise specified.

FIG. 1 is a block diagram of an illustrative embodiment of a sensor in accordance with the principles of claimed subject matter.

FIG. 2 is a flow chart of an illustrative embodiment of sensing operation in accordance with the principles of claimed subject matter.

FIG. 3 is a detailed block diagram of an illustrative embodiment of a sensor in accordance with the principles of claimed subject matter.

FIGS. 4A and 4B are, respectively, top plan and portrait views of an illustrative embodiment of a test stand in accordance with the principles of claimed subject matter.

FIG. 5 is a block diagram of an illustrative embodiment of a control system in accordance with the principles of claimed subject matter.

FIG. 6 is a block diagram of an illustrative embodiment of a processor that may be employed in an illustrative embodiment of a control system or test stand in accordance with the principles of claimed subject matter.

### DESCRIPTION OF THE PREFERRED EMBODIMENTS

Although claimed subject matter will be described in terms of certain embodiments, other embodiments, including embodiments that do not provide all of the benefits and features set forth herein, are also within the scope of this invention. Various structural, logical, process step, and electronic changes may be made without departing from the spirit or scope of the invention. Flow charts may include steps that may be deleted or otherwise modified and the sequence set forth within a particular flow chart may be modified while keeping within the scope of the invention. Accordingly, the scope of the invention is defined only by reference to the appended claims.

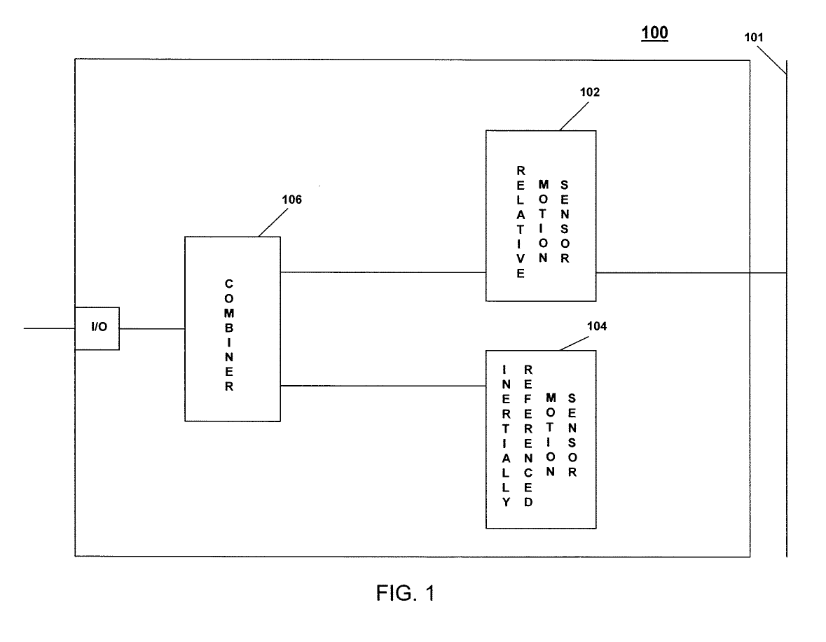

The block diagram of FIG. 1 provides a functional view of an embodiment of an inertially referenced motion sensor 100 in accordance with the principles of claimed subject matter. In this illustrative embodiment, sensor 100 includes a relative motion sensor 102, inertially referenced motion sensor 104, and a signal combiner 106. Relative motion sensor 102 develops a signal that is representative of the motion relationship between the sensor 100 and an object 101 being sensed. That is, sensor 102 is “relative” in the sense that the signal sensor 102 develops is related to motion differences between itself and an object 101 being sensed. Inertially referenced motion sensor 104 is rigidly coupled to relative motion sensor 102. Should relative motion sensor 102 move, due to vibration for example, inertially referenced motion sensor 104 senses movement of relative motion sensor 100 and develops a signal representative of that movement relative to an inertial reference frame. Signals from relative motion sensor 102 and inertially referenced motion sensor 104 are sent to a signal combiner 106, where they are combined to yield a signal that is representative of the motion relationship between the object being sensed 101 and the inertial reference frame.

Relative motion sensor 102 may be embodied as any of a variety of motion sensors, including without limitation displacement, velocity, acceleration, or jerk sensors. Similarly, inertial-reference sensor 104 may be embodied as any of a variety of motion sensors, including without limitation displacement, velocity, acceleration, or jerk sensors. In an illustrative embodiment, relative motion sensor 102 may employ a non-contact sensing technique, including capacitive, magnetic, or electromagnetic (e.g. optical or microwave), for example, or may employ contact sensing, such as that of linear variable differential transformer (LVDT), for example. Relative motion sensor 102 or inertially referenced motion sensor 104 may include embodiments which employ any of a variety of manufacturing technologies, including discrete components, hybrid, chip-on-glass, microelectromechanical system (MEMS), analog or digital integrated circuit, surface mount, bump-bonded, programmable analog and/or digital array, or printed circuit manufacturing technologies, for example. In illustrative embodiments sensor 100 may include firmware, software, microcode, a microcontroller, or digital signal processor, one or more processors, controllers, microprocessors, microcontrollers, application specific integrated circuits, digital signal processors, programmable logic devices, field programmable gate arrays, and the like, or any combination thereof, for example.

For applications in which uniaxial motion of an object 101 is the subject of sensing, inertial-reference sensor 104 may be rigidly coupled to relative motion sensor 102 in a manner that ensures that any motion of relative motion sensor 102 along the axis of motion that is of interest in the object being sensed is sensed by inertially referenced motion sensor 104. This may be accomplished, for example, by positioning the sensing mechanism of inertially referenced motion sensor 104 in-line with, or, if negligible rotational motion of sensor 100 is anticipated, in parallel with, the axis of motion of interest in the object being sensed, for example.

Signals developed by relative motion sensor 102 and inertial-reference sensor 104 may be analog or digital signals and they may be post-processed within an inertially referenced motion sensor. Post-processing may include signal conditioning, level-adjustment, digital signal processing, differentiation, or integration, for example. Sensor 100 may include an input/output interface I/O which may comprise digital or analog signals, any of which may be wireless signals (e.g., radio frequency (RF), or infrared (IR)). Interface I/O may conform to a standard interface, for example.

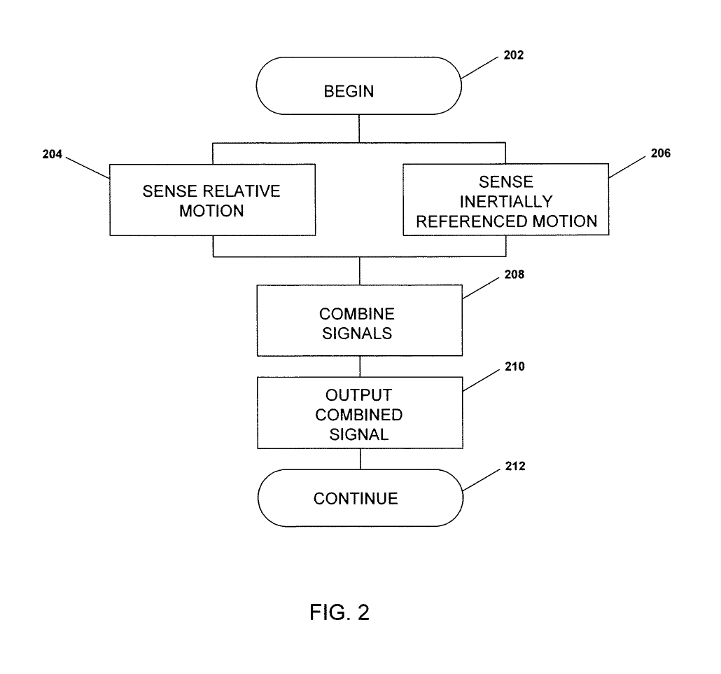

The flowchart of FIG. 2 depicts an illustrative embodiment of a method in accordance with the principles of claimed subject matter. The process begins in step 202 and proceeds from there to step 204 where a relative motion sensor senses the motion relationship between the sensor itself and an object, or a surface or location on a surface, of an object being sensed. As indicated by FIG. 2, step 206 where an inertially referenced motion sensor senses the motion relationship of itself to an inertial reference frame, may be carried out simultaneously with step 204. In an illustrative embodiment, the inertially referenced sensor is rigidly coupled to, and may be integrated with, the relative motion sensor. In illustrative embodiments steps 204 and 206 may take place simultaneously. From 206 the process proceeds to step 208 where signals from the relative and inertially referenced motion sensors are combined. The signals are combined to substantially eliminate any artifact of the sensors' movement, thereby producing a signal that represents the motion relationship between an object being sensed and an inertial reference frame. In step 210 an inertially referenced relative signal is provided by an inertially referenced sensor in accordance with the principles of claimed subject matter. Such an output signal may be employed by analytical, metrological, or control system equipment, for example. From step 210 the process continues to step 212 where a sensor in accordance with the principles of claimed subject matter continues the process of providing inertially referenced motion sensing output.

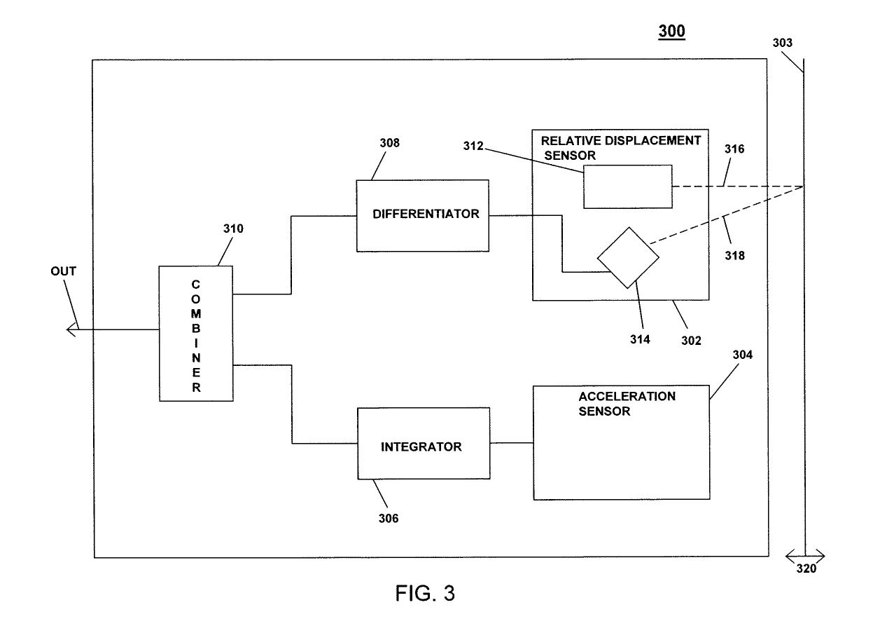

As previously noted, relative and inertially referenced motion sensors may be implemented as any type of motion sensor (e.g., displacement, velocity, acceleration, or jerk), with outputs combined after appropriate transformations, as necessary. Such transformations will be described in greater detail in the discussion related to FIG. 3, for example. A relative motion sensor may employ any sensing technology (e.g., magnetic, capacitive, or electromagnetic (e.g., optical or microwave)). Relative or inertially referenced motion sensors may include embodiments which employ any of a variety of manufacturing technologies, including discrete component, hybrid, chip-on-glass, MEMS, analog or digital integrated circuit, surface mount, bump-bonded, programmable analog and/or digital array, or printed circuit manufacturing technologies, for example. In an illustrative embodiment, an optical displacement sensor may produce a relative motion sensor output related to an object being sensed, an accelerometer may produce an inertially referenced motion sensor output related to the motion of the sensor pair relative to an initial reference frame and a difference circuit may combine the outputs to form a inertially referenced signal representative of the motion relationship between an object being sensed and an inertial reference frame, for example.

In the illustrative block diagram of FIG. 3, an illustrative embodiment of an inertially referenced displacement sensor 300 includes a relative displacement sensor 302 configured to sense displacement of a target structure surface 303 relative to the sensor 302. Acceleration sensor 304 senses inertially referenced acceleration of the sensor 300 and the acceleration signal provided by sensor 304 is routed to integrator 306 where the signal is integrated to produce an inertially referenced velocity output signal. The relative displacement signal produced by non-contact displacement sensor 302 is sent to a differentiator 308 where the signal is differentiated to produce a relative velocity signal. Velocity signals from the integrator 306 and the differentiator 308 are supplied to combiner 310. In this illustrative embodiment, the combiner is a differencing circuit and the combiner 310 subtracts the integrated acceleration sensor output from the differentiated displacement sensor output to produce a velocity output from which any artifact related to the motion of displacement sensor 302 is removed, thereby providing an output signal that is representative of the velocity of the structure being sensed 303 relative to an inertial reference frame. In this illustrative embodiment, displacement sensor 302 includes an optical source 312 and an optical receiver 314 and determines the distance to the structure surface 303 by triangulation, as is known in the art.

In an illustrative embodiment the light source 312 is a laser source and the receiver 314 is a linear charge coupled device (CCD) array. Such non-contact displacement sensors are known. Illustrative embodiments of such a sensor are the LK-G87 and LK-G157, available from Keyence Corporation of America, 50 Tice Boulevard, Woodcliff Lake, N.J., 07677. In an illustrative embodiment, the accelerometer may be a MEMS device. Such accelerometers are known. An illustrative embodiment of such a sensor is a 4002 accelerometer, available from Measurement Specialties, 1000 Lucas Way, Hampton, Va. 23666. In an illustrative embodiment, an optical triangulation displacement sensor 302 may provide desirable dynamic range, bandwidth, minimal time delay, and insensitivity to angle of incidence. Additionally, such a sensor may operate effectively with a sensed object having a wide range of colors, textures and surface roughness. A non-contact velocity sensor such as a laser Doppler velocimeter featuring otherwise similar performance may be preferable for operation with an accelerometer 304, due to a better-matched noise floor. In an illustrative embodiment in which a highly accurate frequency response over a range from 1 to 100 Hz is desired, accelerometers are particularly well-suited. Additionally, accelerometers with DC response, which provide for excellent channel matching characteristics with triangulation displacement sensors down below 1 Hz, are known and relatively inexpensive. In an illustrative embodiment, both integration and differentiation, carried out by integrator 306 and differentiator 308, respectively, may be minimized in order to avoid the introduction of errors. Integration, for example, may present challenges at maintaining frequency response at low frequencies while preventing large offsets and drift at low frequencies. Differentiation may require filtering at high frequencies. Both operations reshape the noise properties of the respective original sensors. Velocity signals, employed in this illustrative embodiment as inputs to a differencing circuit (i.e., combiner 310), are a convenient form, given an embodiment in which a relative motion sensor 302 is a displacement sensor and inertially referenced motion sensor 304 is an accelerometer. In an illustrative embodiment in which combiner 310 employs a differencing circuit, the circuit may require tight matching of the two input legs with respect to magnitude and phase accuracy.

In this illustrative embodiment, the displacement sensor 302 employs a linear CCD array receiver 324, the accelerometer 304 is a uniaxial accelerometer, and the displacement sensor detects displacement of the surface 303 substantially in-line with the direction of the source beam 316. That is, the displacement measured is substantially directly toward or away from the source 312, as indicated by directional arrows 320. Other embodiments which operate with more than one degree of freedom and which employ a two dimensional CCD array for a receiver 314 and a triaxial MEMS for an accelerometer, for example, may be employed. Differentiator 308, integrator 306, and combiner 310 may be implemented using analog circuitry, digital circuitry, including digital signal processing circuitry, or a combination thereof, for example. In an illustrative embodiment, displacement sensor 302 and accelerometer 304 may be packaged separately, but mated to ensure that any motion of displacement sensor 302 is reflected in accelerometer 304, for example. Integrator 306, differentiator 308, and combiner 310 may also be mated to, or packaged with displacement sensor 302 and accelerometer 304. An inertially referenced output signal, such as signal OUT, from combiner 310 may be analog, digital, or a combination of both and may be in the format of a serial or parallel interface and may employ wireless signaling, for example. In an illustrative embodiment, the magnitude and phase response, time delay, and nonlinearity of accelerometer 304 may be compensated for by inserting an estimate of the forward dynamics of accelerometer 304 into the path of the displacement sensor 302, or by inserting an estimate of the inverse dynamics of the accelerometer in its own path, for example

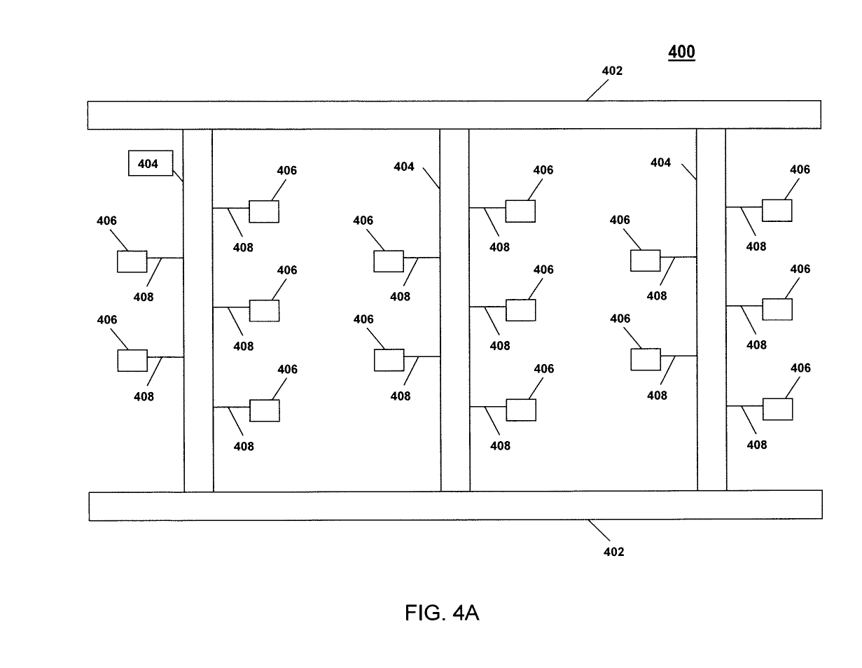

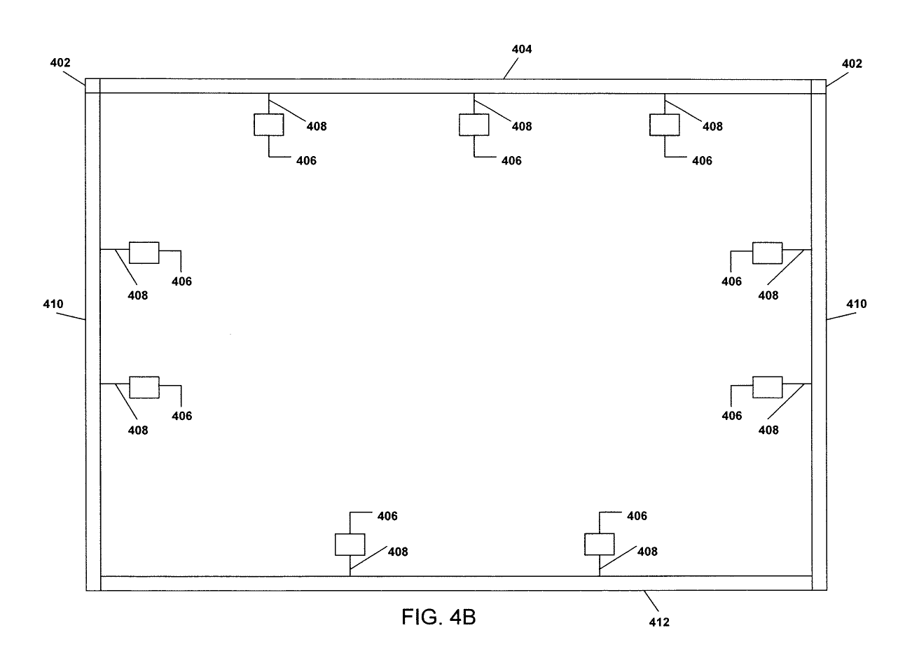

As previously noted, an inertially referenced motion sensor in accordance with the principles of claimed subject matter may be employed in a variety of vibrational analysis and control system applications, for example. FIG. 4A is a top plan view of an illustrative embodiment of a sensor support stand 400. Sensor support stand 400 may include a support structure that includes top support members 402, top cross support members 404, and one or more inertially referenced motion sensors 406. Inertially referenced motion sensors 406 may be mounted on top support members 402 or top support cross members 404, for example. Sensors 406 may be directly mounted, or mounted through an arm 408, for example. Arm 408 may be a rigid tube or beam, and may be adjustable in length or angle, for example. Arm 408 may include a bracket, clamp, screws, or other mounting means, any of which may enable positional adjustment of sensor 406. A sensor support stand may employ arm 408 to position sensor 406 within range of an object to be sensed, for example. In an illustrative embodiment, sensors 406 may be rigidly mounted on a support structure. FIG. 4B is a portrait view of an illustrative embodiment 400 of a sensor support stand. In this illustrative embodiment, sensors 406 may be suspended from vertical support members 410, top support members 402, cross support members 404, or bottom cross support members 412, for example. Inertially referenced motion sensors 406 may be configured to test the vibrational characteristics of an object, such as a structure, machine, or article of manufacture, all, or a portion, of which may be encompassed by test stand 400, for example. Sensor support stand 400 may be constructed to minimize vibration within itself and, particularly, to minimize motion of sensors 406 in relation to an inertial reference frame. Inertially referenced motion sensors 406 are configured to substantially eliminate the effects of any residual vibration within the sensor support stand 400. Such a sensor support stand 400 may be employed to test resonant properties of large and high-value structures, for example, and may reduce the down time associated with modal testing of high-value structures. As is known in the art, modal testing analyzes resonant properties of a structure. Such tests are regularly performed on aircraft that are new in development, or have been modified, in order to verify margins against flutter, a phenomenon that can cause an aircraft to self-destruct in flight. A sensor support stand 400 may be employed in modal analysis of aircraft, whether in production or in development, including airplanes, satellites, and rockets, for example.

In an illustrative modal analysis vibrational sensor support stand 400 embodiment, a plurality of non-contact inertially referenced motion sensors 406 may be mounted on a sensor support stand 400 that supports the sensors 406 in sufficient proximity to a subject structure under test to allow the sensors 406 to sense the structure's response to one or more driving forces. Signals from the non-contact inertially referenced motion sensors 406 may be combined to produce a modal analysis of the object under test. During modal analysis of an object, such as an airframe, non-contact inertially referenced motion sensors 406 provide signals that are substantially free of signal contamination from movement of the sensor support stand 400. After a set of modal analysis tests, the object (e.g., airframe) may be moved for other tests or for structural modifications, for example. The object may then be returned to the sensor support stand 400 for further vibrational testing. Because sensors in accordance with the principles of claimed subject matter need not contact the airframe, they may remain affixed to the sensor support stand 400 and ready for further testing of the airframe when it is returned to the sensor support stand 400. By eliminating the set-up (and tear-down) time that might otherwise be required, a sensor support stand in accordance with the principles of claimed subject matter may substantially reduce costs associated with such tests, for example. In a manufacturing test environment, similar structures, such as airframes, wings, airframe parts, wind turbine blades, or other mechanical structures, particularly large or complex mechanical structures, may be tested sequentially as they are manufactured, using sensor support stand 400, for example. With the structures ostensibly having the same dimensions, structures may be brought to the sensor support stand 400, tested, then moved to make room for the next structure to be tested, with minimal, or no adjustment of sensor 406 location required.

Tests performed with the test stand 400 may be modal analysis or other vibrational testing, for example. Conventional modal analysis, or GVT, tests of aircraft require sensors, such as accelerometers, to be fastened to an aircraft body at as many as hundreds of locations. Connectivity back to a data acquisition system must be traced and recorded carefully. Locations and orientations of each sensor are key to the results and accelerometers must be located at positions dictated by the needs of the test. Setup time for a test may be on the order of weeks and, to yield meaningful results, they must often be performed at a late stage of development, when aircraft integration is nominally complete, and where costs of down time to the structure are greatest. In accordance with the principles of claimed subject matter, a sensor support stand 400 may be configured, even if the aircraft body to be tested is unavailable for testing at the time the sensor support stand is being configured. During such an illustrative configuration, non-contact inertially referenced motion sensors in accordance with the principles of claimed subject matter may be positioned, locations and orientations recorded, and functional checkouts performed. Then, when an aircraft is committed to test, the assembled sensor support stand may be placed around the aircraft, shakers attached to the aircraft, and measurements performed with little delay. Although such a stand may be built to reduce vibration, non-contact inertially referenced motion sensors in accordance with claimed subject matter may be used to substantially eliminate the effects of whatever residual vibrations may be conveyed to such a sensor support stand 400. By configuring a sensor support stand 400 substantially in parallel with integration of an aircraft to be tested, weeks of valuable aircraft integration time may be saved. Other time and cost savings will be apparent to those in the art.

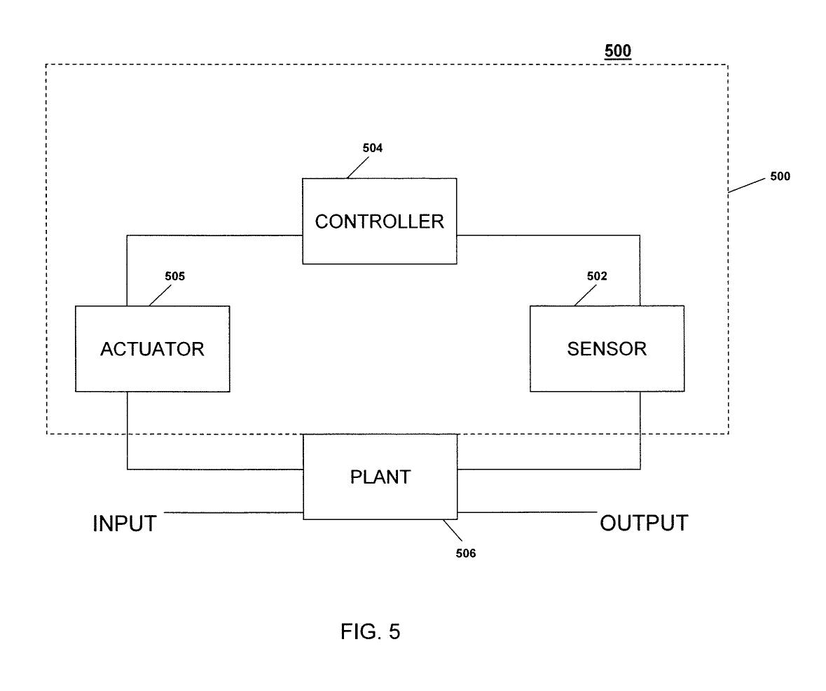

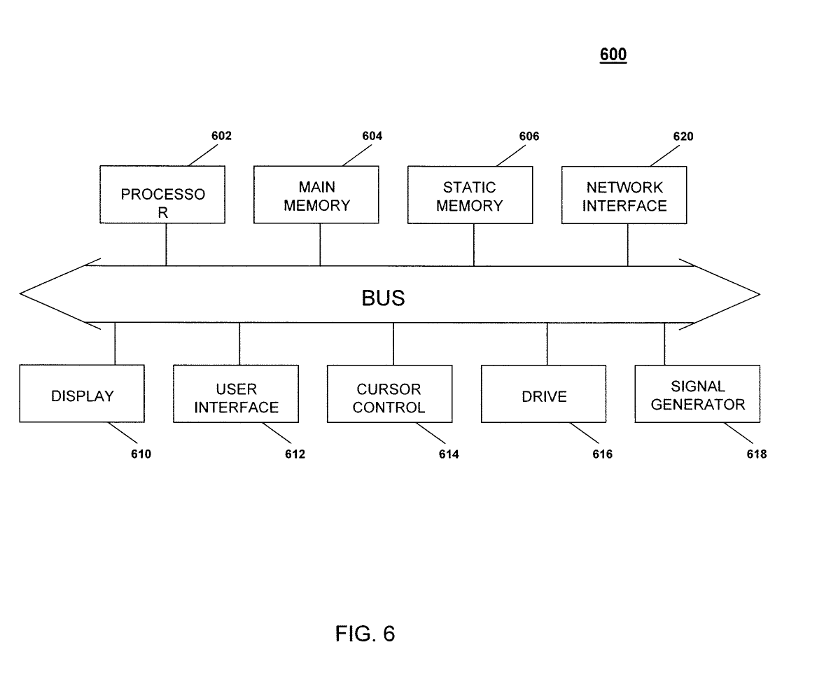

The schematic block diagram of FIG. 5 depicts an illustrative embodiment of a control system 500 in accordance with the principles of claimed subject matter. In this illustrative embodiment one or more inertially referenced motion sensors 502 in accordance with the principles of claimed subject matter provide feedback related to a plant 506 to a controller 504. Controller may be implemented in a variety of technologies, using various architectures, for example. An illustrative embodiment of such a controller is described in greater detail in the discussion related to FIG. 6. Sensor 502 may be employed to control processes in which motion measurements might otherwise be corrupted, or limited in accuracy, by virtue of vibrations within the structures supporting sensors 502, for example. In this illustrative embodiment controller 504 controls actuator 505 which effects changes in the plant 506. Inputs to and outputs from the plant 506 vary depending upon the process being controlled, and may include raw goods or stock as inputs and manufactured goods as output, for example. Alternatively, plant 506 may be embodied as a vehicle and control system 500 may be employed in operation of the vehicle, as described in greater detail below, for example.

In illustrative embodiments the support structure for sensors 502 may be substantially stable, with a work piece, or article of manufacture, being moved relative to sensors 502 during processing. In stationary sensor embodiments, a control system in accordance with the principles of claimed subject matter may monitor dimensions, such as width, thickness, or contour of a manufactured good and adjust the process according to sensed dimensions, for example. Thicknesses and widths may be measured by employing sensors on either side, or on top and bottom, of a good being measured, for example. Such manufacturing processes may generate vibrations that interfere with accurate measurements. A control system that employs inertially referenced motion sensors in accordance with the principles of claimed subject matter may substantially eliminate the effects of such unwanted vibrations, thereby allowing for more precise control. In stationary sensor embodiments, sensors in accordance with the principles of claimed subject matter may be mounted on an external frame or may be attached to, or integrated with, equipment such as manufacturing equipment, for example.

Alternatively, in non-stationary sensor embodiments, sensors 502 may be mounted on a structure that, during process operations, moves in relation to an object that is being sensed and operated upon. For example, sensors 502 may be mounted on a piece of heavy equipment that is performing a leveling operation, for example. That is, a control system 500 may be employed in the operation of complex equipment, using inertially referenced motion sensors to determine relative movement of one part of the equipment with respect to another part of the equipment, to determine the distance between a moving piece of equipment and a stationary target, or between a moving target and a stationary piece of equipment, for example. A controller 504 may utilize inertially referenced motion sensors 502 to provide more accurate control of a process, such as surface-leveling, for example.

FIG. 6 is a schematic diagram of an illustrative embodiment of a processor 600 which may employed by a test stand 400 for vibrational testing of a structure or by a control system 500 to control a process wherein an inertially referenced motion sensor in accordance with claimed subject matter may be employed. Processor 600 includes a processor 602 (e.g., a processor core, a microprocessor, a computing device, etc), a main memory 604 and a static memory 606, which communicate with each other via a bus 608. The processor 600 may further include a display unit 610 that may comprise a touch-screen, or a liquid crystal display (LCD), or a light emitting diode (LED) display, or a cathode ray tube (CRT), for example. As shown, processor 600 also includes a human input/output (I/O) device 612 (e.g., a keyboard, an alphanumeric keypad, etc), a pointing device 614 (e.g., a mouse, a touch screen, etc), a drive unit 616 (e.g., a disk drive unit, a CD/DVD drive, a tangible computer readable removable media drive, an SSD storage device, etc), a signal generation device 618 (e.g., a speaker, an audio output, etc), and a network interface device 618 (e.g., an Ethernet interface, a wired network interface, a wireless network interface, a propagated signal interface, etc).

All or part of the processor 600, and the processes and methods as further described herein, may be implemented using or otherwise including hardware, firmware, software, or any combination thereof. By way of example but not limitation, processor 600 may include one or more processors, controllers, microprocessors, microcontrollers, application specific integrated circuits, digital signal processors, programmable logic devices, field programmable gate arrays, and the like, or any combination thereof. Processor 600 may include an operating system, one or more applications, and one or more drivers. It is to be understood that other embodiments may be used, for example, or changes or alterations, such as structural changes, may be made. All embodiments, changes or alterations, including those described herein, are not departures from scope with respect to intended claimed subject matter.

Reference throughout this specification to “one embodiment” or “an embodiment” or “an illustrative embodiment” means that a particular feature, structure, or characteristic described in connection with the embodiment is included in at least one embodiment of claimed subject matter. Thus, the appearances of the phrase “in one embodiment” or “an embodiment” or “an illustrative embodiment” in various places throughout this specification are not necessarily all referring to the same embodiment. Furthermore, the particular features, structures, or characteristics may be combined in one or more embodiments. While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. An apparatus, comprising:
a relative motion sensor configured to sense a motion relationship between itself and an object;
an inertially referenced motion sensor rigidly coupled to the relative motion sensor and configured to sense a motion relationship between itself and an inertial reference frame; and
a combiner configured to combine output signals from the relative and inertially referenced motion sensors to produce a signal representative of a motion relationship between the object and an inertial reference frame.

2. The apparatus of claim 1, wherein the relative motion sensor is selected from a group consisting of displacement, velocity, acceleration and jerk sensors, or a fractional combination of said sensors.

3. The apparatus of claim 1, wherein the inertially referenced motion sensor is selected from a group consisting of displacement, velocity, acceleration and jerk sensors, or a fractional combination of said sensors.

4. The apparatus of claim 1, wherein the relative motion sensor is a non-contact optical displacement sensor.

5. The apparatus of claim 4, wherein the inertially referenced motion sensor is an accelerometer.

6. The apparatus of claim 5, and further comprising:
a differentiator configured to differentiate an output of the displacement sensor; and
an integrator configured to integrate an output of the accelerometer.

7. The apparatus of claim 6, wherein the combiner is a differencer configured to difference the output of the integrator and the output of the differentiator.

8. An apparatus, comprising:
a non-contact optical displacement sensor;
an accelerometer rigidly coupled to the displacement sensor;
a differentiator configured to differentiate an output signal from the displacement sensor;
an integrator configured to integrate an output signal from the accelerometer; and
a differencer configured to difference an integrated output signal from the integrator and a differentiated output signal from the differentiator.

9. The apparatus of claim 8, wherein the displacement sensor is a laser triangulation displacement sensor.

10. The apparatus of claim 9, wherein the accelerometer is a microelectromechanical system (MEMS) accelerometer.

11. An apparatus, comprising:
a sensor support structure; and
an inertially referenced motion sensor mounted on the support structure, said inertially referenced motion sensor including:
a relative motion sensor configured to sense a motion relationship between itself and an object;
an inertially referenced motion sensor rigidly coupled to the relative motion sensor and configured to sense a motion relationship between itself and an inertial reference frame; and
a combiner configured to combine output signals from the relative and inertially referenced motion sensors to produce a signal representative of a motion relationship between the object and an inertial reference frame.

12. The apparatus of claim 11, and further comprising:
a processor configured to receive a signal from the inertially referenced motion sensor.

13. The apparatus of claim 12, wherein the processor is configured to analyze a signal received from the inertially referenced motion sensor.

14. The apparatus of claim 13, wherein the processor is configured to analyze vibrational characteristics of an object based on a signal received from the inertially referenced motion sensor.

15. The apparatus of claim 14, wherein the processor is configured to analyze modal vibration characteristics of an object based on a signal received from the inertially referenced motion sensor.

16. The apparatus of claim 15, wherein the processor is configured to analyze modal vibration characteristics of an airframe based on a signal received from the inertially referenced motion sensor.

17. The apparatus of claim 14, wherein the processor is configured to analyze the vibrational characteristics of an engine.

18. The apparatus of claim 12, wherein the processor is configured to measure a dimensional attribute of a workpiece based on a signal received from the inertially referenced motion sensor.

19. The apparatus of claim 18, wherein the processor is configured to measure the thickness of a workpiece based on a signal received from the inertially referenced motion sensor.

20. The apparatus of claim 18, wherein the processor is configured to measure the width of a workpiece based on a signal received from the inertially referenced motion sensor.

21. The apparatus of claim 18, wherein the processor is configured to measure a contour of a workpiece based on a signal received from the inertially referenced motion sensor.

22. An apparatus, comprising:
a processor configured to control a process; and
an inertially referenced motion sensor configured to supply a signal to the processor representative of a motion relationship between the sensor and an object involved in the process, the sensor including:
a relative motion sensor configured to sense a motion relationship between itself and an object;
an inertially referenced motion sensor rigidly coupled to the relative motion sensor and configured to sense a motion relationship between itself and an inertial reference frame; and
a combiner configured to combine output signals from the relative and inertially referenced motion sensors to produce a signal representative of a motion relationship between the object and an inertial reference frame.

23. The apparatus of claim 22, wherein the sensor is stationary.

24. The apparatus of claim 23, wherein the process being controlled is a manufacturing process.

25. The apparatus of claim 22, wherein the sensor is non-stationary.

26. A method, comprising:
a relative motion sensor sensing a motion relationship between itself and an object;
an inertially referenced motion sensor rigidly coupled to the relative motion sensor sensing a motion relationship between itself and an inertial reference frame; and
a combiner combining output signals from the relative and inertially referenced motion sensors to produce a signal representative of a motion relationship between the object and an inertial reference frame.

27. The method of claim 26, wherein the relative motion sensor is selected from a group consisting of displacement, velocity, acceleration, and jerk sensors, or a fractional combination of said sensors.

28. The method of claim 26, wherein the inertially referenced motion sensor is selected from a group consisting of displacement, velocity, acceleration, or jerk sensors, or a fractional combination of said sensors.

29. A method, comprising:
an optical displacement sensor sensing a motion relationship between itself and an object;
an accelerometer rigidly coupled to the displacement sensor sensing its motion relative to an inertial reference frame;
a differentiator differentiating an output from the displacement sensor;
an integrator integrating an output from the accelerometer; and
a differencer differencing an integrated output from the integrator and a differentiated output from the differentiator.

30. A method, comprising:
supporting an inertially referenced motion sensor on a support structure; and
producing a signal representative of a motion relationship between the sensor and an object proximate said sensor, said inertially referenced motion sensor including:
a relative motion sensor configured to sense a motion relationship between itself and an object;
an inertially referenced motion sensor rigidly coupled to the relative motion sensor and configured to sense a motion relationship between itself and an inertial reference frame; and
a combiner configured to combine output signals from the relative and inertially referenced motion sensors to produce a signal representative of a motion relationship between the object and an inertial reference frame.

31. The method of claim 30, and further comprising:
a processor receiving a signal from the inertially referenced motion sensor.

32. The method of claim 31, wherein the processor analyzes a signal received from the inertially referenced motion sensor.

33. The method of claim 31, wherein the processor analyzes vibrational characteristics of an object based on a signal received from the inertially referenced motion sensor.

34. The method of claim 33, wherein the processor analyzes modal vibration characteristics of an object based on a signal received from the inertially referenced motion sensor.

35. The method of claim 34, wherein the processor analyzes modal vibration characteristics of an airframe based on a signal received from the inertially referenced motion sensor.

36. The method of claim 33, wherein the processor analyzes vibrational characteristics of an engine.

37. The method of claim 32, wherein the processor measures a dimensional attribute of a workpiece based on a signal received from the inertially referenced motion sensor.

38. A method, comprising:
a relative motion sensor sensing a motion relationship between itself and an object;
an inertially referenced motion sensor rigidly coupled to the relative motion sensor sensing a motion relationship between itself and an inertial reference frame;
a combiner combining output signals from the relative and inertially referenced motion sensors to produce a signal representative of a motion relationship between the object and an inertial reference frame;
a processor receiving a signal from the combiner; and
the processor controlling a process based on the signal from the combiner.
